(19) United States
(12) Patent Application Publication
(10) Pub. No.: US 2020/0172015 A1
(43) Pub. Date: Jun. 4, 2020

(54) LIGHT SENSING REAR-VIEW MIRROR ASSEMBLY

(71) Applicant: Stephen Baird, Hendersonville, TN (US)

(72) Inventor: Stephen Baird, Hendersonville, TN (US)

(21) Appl. No.: 16/208,722

(22) Filed: Dec. 4, 2018

(51) Int. Cl. B60R 1/08; G02F 1/163; B60R 1/06

(52) U.S. Cl. CPC B60R 1/088; B60R 1/0605; G02F 1/163

(57) ABSTRACT

A light sensing rear-view mirror assembly for reducing glare during night driving includes a commercial vehicle. A pair of rear view mirrors is provided and each of the rear view mirrors is each mounted on a respective one of a driver's side and a passenger's side of the commercial vehicle. A pair of control circuits is each coupled to a respective one of the rear view mirrors. A pair of dimming units is each coupled to a respective one of the rear view mirrors. Each of the dimming units is electrically coupled to the control circuit on the respective rear view mirror. Moreover, each of the dimming units automatically reducing an intensity of light reflected in the respective rear view mirror wherein each of the dimming units is configured to enhance a driver's night vision.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to light sensing devices and more particularly pertains to a new light sensing device for reducing glare during night driving.

### BRIEF SUMMARY OF THE INVENTION

An embodiment of the disclosure meets the needs presented above by generally comprising a commercial vehicle. A pair of rear view mirrors is provided and each of the rear view mirrors is each mounted on a respective one of a driver's side and a passenger's side of the commercial vehicle. A pair of control circuits is each coupled to a respective one of the rear view mirrors. A pair of dimming units is each coupled to a respective one of the rear view mirrors. Each of the dimming units is electrically coupled to the control circuit on the respective rear view mirror. Moreover, each of the dimming units automatically reducing an intensity of light reflected in the respective rear view mirror wherein each of the dimming units is configured to enhance a driver's night vision.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a rear view mirror of a light sensing rear-view mirror assembly according to an embodiment of the disclosure.

FIG. 2 is a back perspective view of a rear view mirror of an embodiment of the disclosure.

FIG. 3 is a back phantom view of a rear view mirror of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

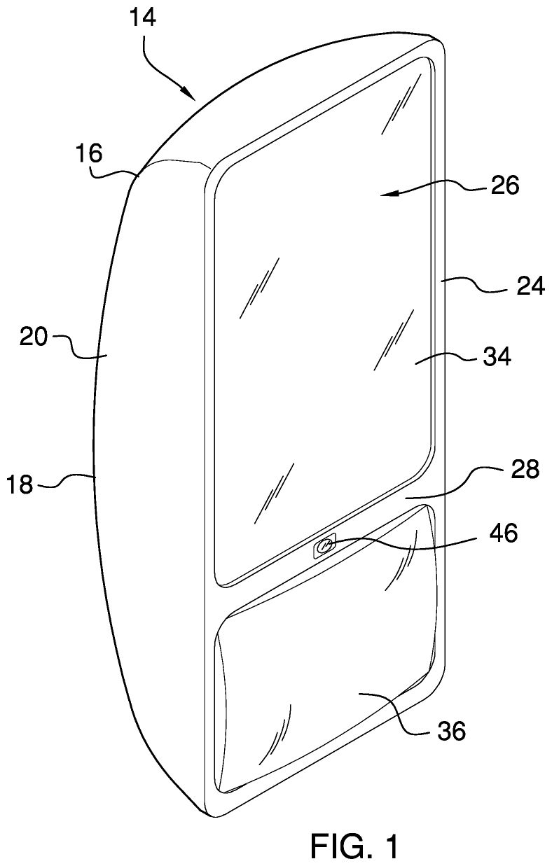

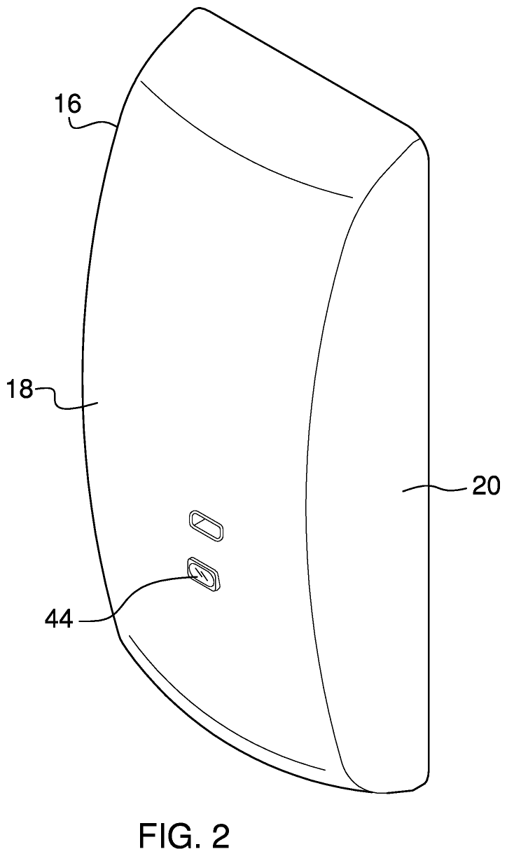

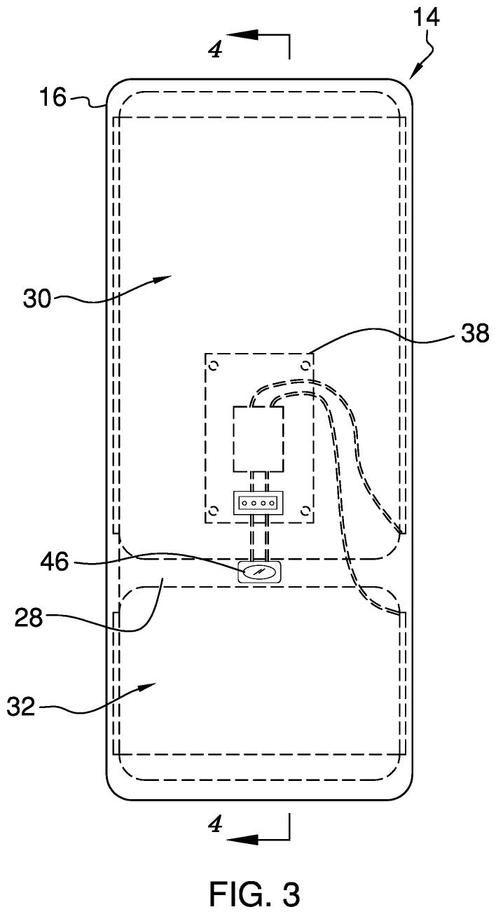

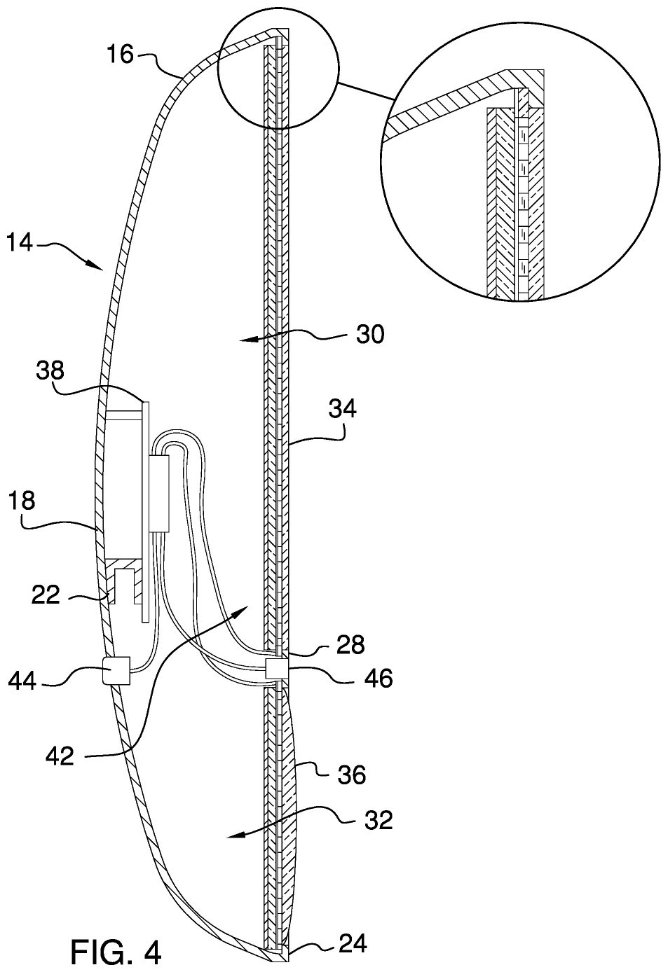

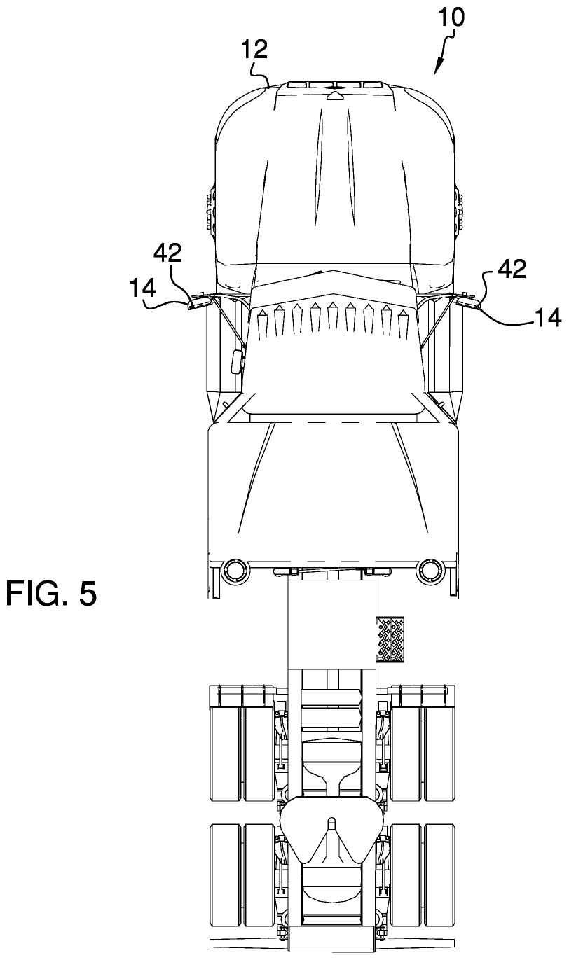

With reference now to the drawings, and in particular to FIGS. 1 through 5 thereof, a new light sensing device embodying the principles and concepts of an embodiment of the disclosure and generally designated by the reference numeral 10 will be described.

As best illustrated in FIGS. 1 through 5, the light sensing rear-view mirror assembly 10 generally comprises a commercial vehicle 12 being driven on public roadways. The commercial vehicle 12 may be a semi-tractor, a box truck and any other type of commercial vehicle 12 employed for transporting cargo on the public roadways. A pair of rear view mirrors 14 is each mounted on a respective one of a driver's side and a passenger's side of the commercial vehicle 12.

Each of the rear view mirrors 14 comprises a housing 16 that has a front wall 18 and an outer wall 20 extending rearwardly therefrom. A power port 22 is positioned within the housing 16 and the power port 22 faces downwardly in the housing 16. The outer wall 20 has a distal edge 24 with respect to the front wall 18 defining an opening 26 into the housing 16. The outer wall 20 is mounted to the commercial vehicle 12 having the opening 26 being directed rearwardly on the commercial vehicle 12. Additionally, the housing 16 includes a divider 28 that is coupled to the outer wall 20 and extending laterally across the opening 26 to define an upper portion 30 of the opening 26 and a lower portion 32 of the opening 26.

Each of the rear view mirrors 14 includes a first mirror 34 that is positioned in the housing 16 to reflect light being emitted from behind the commercial vehicle 12. The light being emitted from behind the commercial vehicle 12 may be light from headlights on a vehicle that is following the commercial vehicle 12 or other similar light source. The first mirror 34 is positioned in the upper portion 30 of the opening 26 in the housing 16 and the first mirror 34 is an electrochromic mirror.

Each of the rear view mirrors 14 includes a second mirror 36 that is positioned in the housing 16 to reflect light that is emitted from behind the commercial vehicle 12. The second mirror 36 is positioned in the lower portion 32 of the opening 26 in the housing 16 and the second mirror 36 is an electrochromic mirror. Moreover, the electrochromic mirror may include an electrochromic film, a conductive strip and other structural components common to electrochromic mirrors. Additionally, the second mirror 36 may be a blind spot mirror or the like.

A pair of control circuits 38 is provided and each of the control circuits 38 is coupled to a respective one of the rear view mirrors 14. Each of the control circuits 38 is electrically coupled to a power source 40 comprising an electrical system of the commercial vehicle 12. Additionally, a conductor may be electrically coupled to the power port 22 in the housing 16 and each of the control circuits 38 may be electrically coupled to the power port 22 in the respective rear view mirror 14. A pair of dimming units 42 is each coupled to a respective one of the rear view mirrors 14. Each of the dimming units 42 automatically reduces an intensity of light being reflected in the respective rear view mirror 14. In this way each of the dimming units 42 enhances a driver's night vision by reducing glare from headlights or the like.

Each of the dimming units 42 includes a light sensor 44 that is coupled to the outer wall 20 of the housing 16. In this way the light sensor 44 can detect ambient light levels with respect to the housing 16. The light sensor 44 is electrically coupled to a respective one of the control circuits 38. Moreover, the respective control circuit 38 receives a first input when the light sensor 44 senses ambient light levels that exceed a trigger light level. The light sensor 44 may be an electronic light sensor 44 of any conventional design and the trigger light level may be light levels associated with sunset.

A glare sensor 46 is coupled to the divider 28 for detecting light that is directed toward the first 34 and second 36 mirrors. The light being directed toward the first and second mirror 36s may be light from headlights of a vehicle that is following the commercial vehicle 12 or the like. The glare sensor 46 is electrically coupled to a respective one of the control circuits 38. The respective control circuit 38 receives a second input when the glare sensor 46 senses an intensity of light that exceeds a trigger light level. The trigger light level with respect to the glare sensor 46 may be an intensity of light corresponding to high beam headlights on the vehicle following the commercial vehicle 12. Each of the first 34 and second 36 mirrors is actuated to dim an intensity of light being reflected away therefrom when the respective control circuit 38 receives the first and second inputs. In this way each of the first 34 and second 36 mirrors in each of the rear view mirrors 14 reduces glare for a driver of the commercial vehicle 12.

In use, the respective control circuit 38 receives the first input when the light sensor 44 of the respective dimming unit 42 senses the trigger intensity of ambient light. Additionally, the respective control circuit 38 receives the second input when the glare sensor 46 of the respective dimming unit 42 senses the trigger intensity of light being directed onto the rear view mirrors 14. Thus, each of the first 34 and second 36 mirrors in each of the rear view mirrors 14 is actuated to dim the intensity of light being reflected away therefrom. In this way the driver of the commercial vehicle 12 is inhibited from being blinded by high beam headlight of a vehicle that is following the commercial vehicle 12. Thus, the driver's night vision is enhanced thereby increasing the driver's ability to safely drive the commercial vehicle 12 at night.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light sensing rear-view mirror assembly being mounted on a commercial vehicle wherein said assembly is configured to dim reflected headlights, said assembly comprising:
a commercial vehicle;
a pair of rear view mirrors, each of said rear view mirrors each being mounted on a respective one of a driver's side and a passenger's side of said commercial vehicle;
a pair of control circuits, each of said control circuits being coupled to a respective one of said rear view mirrors; and
a pair of dimming units, each of said dimming units being coupled to a respective one of said rear view mirrors, each of said dimming units being electrically coupled to said control circuit on said respective rear view mirror; each of said dimming units automatically reducing an intensity of light reflected in said respective rear view mirror wherein each of said dimming units is configured to enhance a driver's night vision.

2. The assembly according to claim 1, wherein each of said rear view mirrors comprises a housing having a front wall and an outer wall extending rearwardly therefrom, said outer wall having a distal edge with respect to said front wall defining an opening into said housing, said outer wall being mounted to said commercial vehicle having said opening being directed rearwardly on said commercial vehicle, said housing including a divider being coupled to said outer wall and extending laterally across said opening to define an upper portion of said opening and a lower portion of said opening.

3. The assembly according to claim 2, further comprising:
a first mirror being positioned in said housing wherein said first mirror is configured to reflect light being emitted from behind said commercial vehicle, said first mirror being positioned in said upper portion of said opening in said housing, said first mirror being an electrochromic mirror; and
a second mirror being positioned in said housing wherein said second mirror is configured to reflect light emitted from behind said commercial vehicle, said second mirror being positioned in said lower portion of said opening in said housing, said second mirror being an electrochromic mirror.

4. The assembly according to claim 1, wherein:
each of said rear view mirrors includes a housing having an outer wall and a divider; and
each of said dimming units comprises a light sensor being coupled to said outer wall of said housing wherein said light sensor is configured to detect ambient light levels with respect to said housing, said light sensor being electrically coupled to a respective one of said control circuits, said respective control circuit receiving a first input when said light sensor senses ambient light levels that exceed a trigger light level.

5. The assembly according to claim 4, further comprising a glare sensor being coupled to said divider wherein said glare sensor is configured to detect light being directed toward said first and second mirrors, said glare sensor being electrically coupled to a respective one of said control circuits.

6. The assembly according to claim 5, wherein said respective control circuit receives a second input when said glare sensor senses an intensity of light that exceeds a trigger light level, each of said first and second mirrors being actuated to dim an intensity of light being reflected away therefrom when said control circuit receives said first and second inputs wherein each of said first and second mirrors is configured to reduce glare for a driver of said commercial vehicle.

7. A light sensing rear-view mirror assembly being mounted on a commercial vehicle wherein said assembly is configured to dim reflected headlights, said assembly comprising:
a commercial vehicle;
a pair of rear view mirrors, each of said rear view mirrors each being mounted on a respective one of a driver's side and a passenger's side of said commercial vehicle, each of said rear view mirrors comprising:
a housing having a front wall and an outer wall extending rearwardly therefrom, said outer wall having a distal edge with respect to said front wall defining an opening into said housing, said outer wall being mounted to said commercial vehicle having said opening being directed rearwardly on said commercial vehicle, said housing including a divider being coupled to said outer wall and extending laterally across said opening to define an upper portion of said opening and a lower portion of said opening;
a first mirror being positioned in said housing wherein said first mirror is configured to reflect light being emitted from behind said commercial vehicle, said first mirror being positioned in said upper portion of said opening in said housing, said first mirror being an electrochromic mirror; and
a second mirror being positioned in said housing wherein said second mirror is configured to reflect light emitted from behind said commercial vehicle, said second mirror being positioned in said lower portion of said opening in said housing, said second mirror being an electrochromic mirror;
a pair of control circuits, each of said control circuits being coupled to a respective one of said rear view mirrors, each of said control circuits being electrically coupled to a power source comprising an electrical system of said commercial vehicle; and
a pair of dimming units, each of said dimming units being coupled to a respective one of said rear view mirrors, each of said dimming units automatically reducing an intensity of light reflected in said respective rear view mirror wherein each of said dimming units is configured to enhance a driver's night vision, each of said dimming units comprising:
a light sensor being coupled to said outer wall of said housing wherein said light sensor is configured to detect ambient light levels with respect to said housing, said light sensor being electrically coupled to a respective one of said control circuits, said respective control circuit receiving a first input when said light sensor senses ambient light levels that exceed a trigger light level; and
a glare sensor being coupled to said divider wherein said glare sensor is configured to detect light being directed toward said first and second mirrors, said glare sensor being electrically coupled to a respective one of said control circuits, said respective control circuit receiving a second input when said glare sensor senses an intensity of light that exceeds a trigger light level, each of said first and second mirrors being actuated to dim an intensity of light being reflected away therefrom when said control circuit receives said first and second inputs wherein each of said first and second mirrors is configured to reduce glare for a driver of said commercial vehicle.
